(19) United States
(12) Patent Application Publication
(10) Pub. No.: US 2006/0188758 A1
(43) Pub. Date: Aug. 24, 2006

(54) Flow field board arrangement for fuel cell

(76) Inventors: Hsi-Ming Shu, Taipei (TW); Feng-Yi Deng, Taipei (TW); Tsang-Ming Chang, Taipei (TW); Yean-Der Kuan, Taipei (TW); Wei-Li Huang, Taipei (TW)

Correspondence Address: G. LINK CO., LTD, 3550 Bell Road, MINOOKA, IL, 60447, US

(21) Appl. No.: 11/356,059

(22) Filed: Feb. 17, 2006

(30) Foreign Application Priority Data
Feb. 18, 2005 (TW) 094202690

(51) Int. Cl. H01M 8/00

(52) U.S. Cl. 429/12

(57) ABSTRACT

A flow field board arrangement for a fuel cell is disclosed. Injection flow channels and exhaust flow channels are individually disposed on the surface of a substrate. At least a concave portion is disposed on the same, and connected to the injection flow channel and the exhaust flow channel accordingly. An inlet is disposed on the side of the substrate and connected to an end of the injection flow channel. An outlet is disposed on the side of the substrate and connected to an end of the exhaust flow channel. The flow field board arrangement is characterized in that each injection flow channel has an identical length from an influx end of the concave portion to the inlet and/or has an equivalent flow rate, and each exhaust flow channel has an identical length from an efflux end of the concave portion to the outlet and/or has an equivalent flow rate. Additionally, the length of each injection flow channel is identical to that of each exhaust flow channel, and/or the flow rate of each injection flow channel is equivalent to that of each exhaust flow channel.

### FIELD OF THE INVENTION

The present invention relates generally to the flow field board arrangement for membrane electrode assemblies (MEAs) in a fuel cell, and more particularly, to a flow field board arrangement that can provide fuel for each MEA and drain products of the MEA almost at the same time.

### BACKGROUND OF THE INVENTION

A conventional flow field board of a fuel cell includes a flowing field board arrangement like a trench, which is used to drift fuel into a membrane electrode assembly (MEA). However, it is difficult for conventional flow field board to supply fuel from the inlet for each MEA and drain products generated by the electrochemical reaction of MEA almost at the same time. Accordingly, each MEA performs the electrochemical reaction in different environment, resulting in poor electric quality of the fuel cell.

Therefore, an improved flow field board arrangement is provided to overcome the foresaid disadvantages, which can provide fuel for each MEA and drain products of the MEA almost at the same time.

### SUMMARY OF THE INVENTION

It is an object of the invention to provide a flow field board arrangement for a fuel cell, which provides fuel for each MEA almost at the same time.

It is another object of the invention to provide a flow field board arrangement for a fuel cell, which drains products of the MEA almost at the same time.

In accordance with the aforesaid objects of the invention, a flow field board arrangement for a fuel cell is provided. The arrangement comprises a substrate including injection flow channels disposed on the surface thereof, exhaust flow channels disposed on the surface thereof and at least a concave portion disposed on the surface thereof; wherein each concave portion is connected to the corresponding injection flow channel and the corresponding exhaust flow channel. The arrangement also comprises an inlet disposed on a side of the substrate and connected to an end of the injection flow channel, and an outlet disposed on a side of the substrate and connected to an end of the exhaust flow channel. Each injection flow channel has the identical length from an influx end of the concave portion to the inlet and/or has an equivalent flow rate, and each exhaust flow channel has the identical length from an efflux end of the concave portion to the outlet and/or has an equivalent flow rate. Further, each injection flow channel has a length as same as each exhaust flow channel's and/or has a flow rate as same as each exhaust flow channel's.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is a schematic block diagram showing a flow field board arrangement for a fuel cell according to an embodiment of the invention;

FIG. 2 is an elevation view showing a flow field board arrangement of a fuel cell according to one preferred embodiment of the invention;

FIG. 3 is an elevation view showing a fuel cell with a flow board arrangement according to one embodiment of the invention; and

FIG. 4 is an elevation view showing a flow field board arrangement according to another embodiment of the invention.

### DETAILED DESCRIPTION OF THE INVENTION

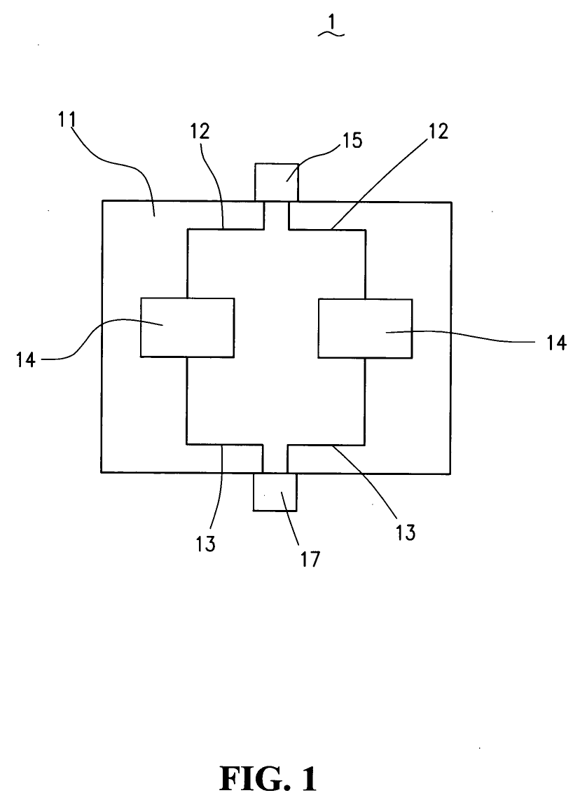

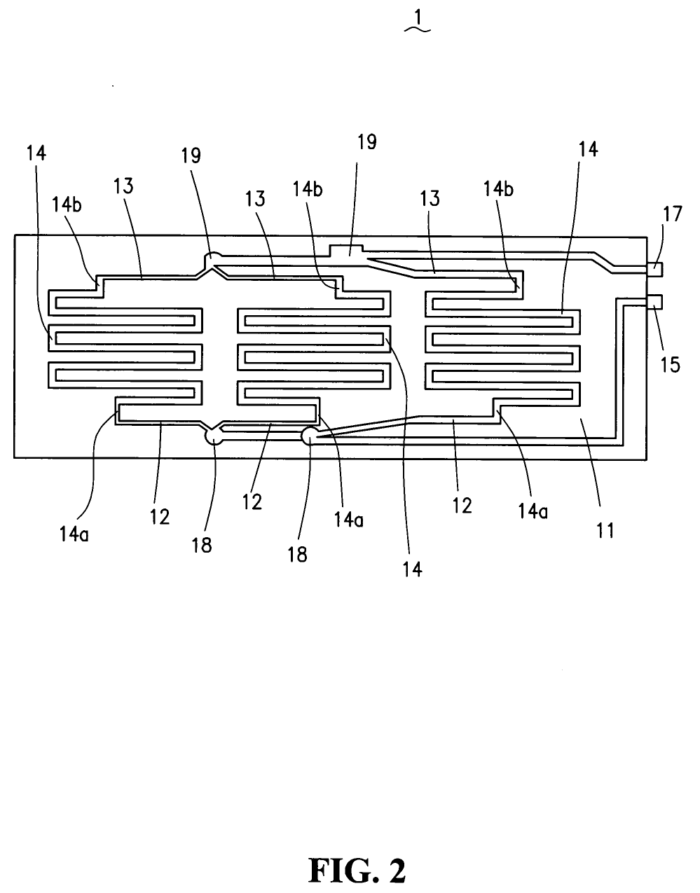

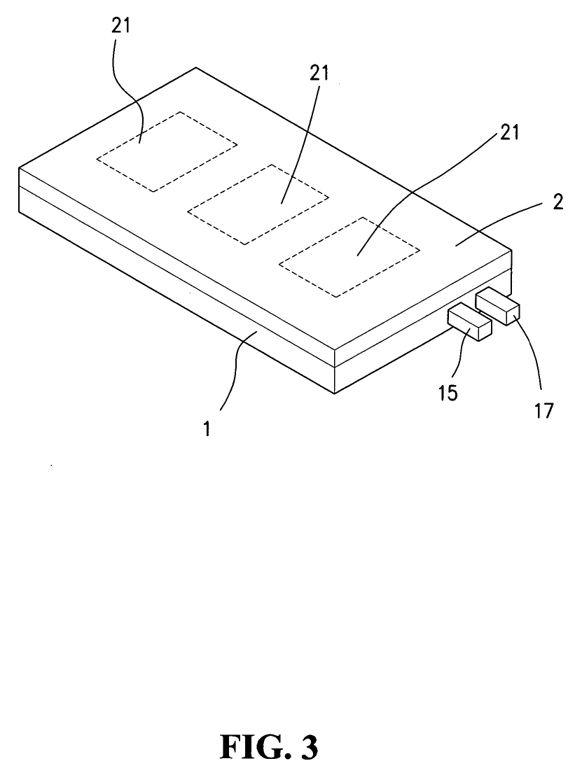

With reference to FIGS. 1 to 3 to illustrate a flow field board arrangement for a fuel cell of the invention, FIG. 1 is a schematic block diagram showing a flow field board arrangement, FIGS. 2 and 3 are elevation views showing a fuel cell with the flow field board arrangement based on the preferred embodiment. The flow field board arrangement 1 for a fuel cell includes a substrate 11, and there are inject flow channels 12, exhaust flow channels 13, concave portions 14; an inlet 15, and an outlet 17 individually disposed on the surface of the substrate 11. As shown in FIG. 1, each concave portion 14 is a zigzag trench, and the influx end 14a and efflux end 14b are connected to a corresponding inject flow channel 12 and a corresponding exhaust flow channel 13, respectively.

In currently preferred embodiments of the invention, it is noted that the length of each inject flow channel 12 from the influx end 14a of every concave portion 14 to the inlet 15 is identical in the flow field board arrangement 1. Furthermore, the flow rate of every inject flow channel 12 is equivalent. Preferably, shown in FIG. 2 exemplarily, there is three inject flow channels 12 separately connected to the influx ends 14a of the concave portions 14 and the inlet 15. These inject flow channels 12 have the same lengths. Also, the length of each exhaust flow channel 13 from the efflux end 14b of every concave portion 14 to the outlet 17 is identical. Alternatively, every exhaust flow channel 13 has an equal flow rate. Moreover, referring to FIG. 2, there are three exhaust flow channels 13 individually connected to the efflux ends 14b of the concave portions 14 and the outlet 17. The lengths of these exhaust flow channels 13 are identical. Furthermore, the length or flow rate of the inject flow channel 12 is the same as that of the exhaust flow channel 13. In this embodiment, three inject flow channels 12 that have equivalent lengths or flow rates and three exhaust flow channels 13 that have equivalent lengths or flow rates are disposed on the substrate 11.

As shown in FIG. 3, a fuel cell board 2, such as a bipolar fuel cell board, is sealed and connected to the flow field board arrangement 1. The bipolar fuel cell board 2 includes a cathode current collection board (not shown), an anode current collection board (not shown) and at least a MEA 21 sandwiched in therebetween. Each MEA 21 corresponds to a concave portion 14. Anode fuel out of the inlet 15 are drifted to the inject flow channels 13, and flow into corresponding MEAs 21 through the corresponding concave portions 14. The products generated by electrochemical reaction of the MEAs 21 respectively flowed into corresponding concave portions 14 and the exhaust flow channels 13, are drained out away from the outlet 17.

Besides, referring to FIG. 2, at least a diverging region 18 and at least a converging region 19 are disposed on the surface of the substrate 11. The diverging region 18 is connected with the inject flow channel 12 for dividing fuel into the branch inject flow channels 12. The converging region 19 is connected to the exhaust flow channel 13 for collecting products of the branch exhaust flow channels 13 and leading the same to another exhaust flow channel 13.

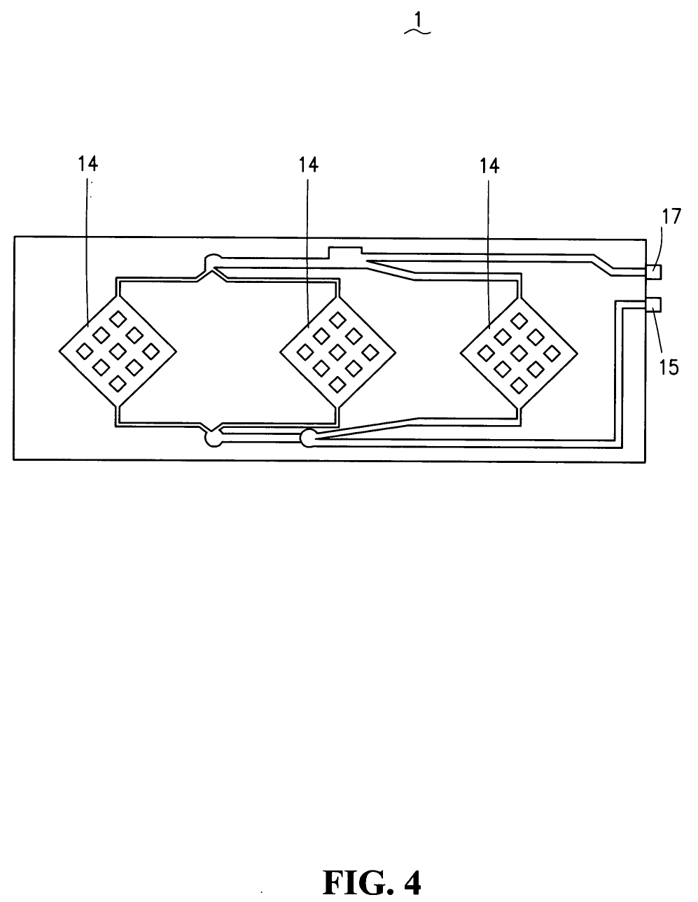

FIG. 4 is an elevation view showing the flow field board arrangement according to another embodiment of the invention. As shown in FIG. 4, each concave portion 14 is a diamond network trench, and the influx end and efflux end are separately connected to corresponding inject flow channel and corresponding exhaust flow channels.

The substrate 11 may be an acid-resisting and anticorrosive metal substrate, which is mechanically fabricated or punch molded to be a flow field board arrangement 1. The substrate 11 is made of, for example, plastics, and is formed to be a flow field board arrangement 1 by injection molding. Besides, the substrate 11 may be an epoxy glass fiber substrate, a ceramic substrate or a polymer plastic substrate. Afterwards, mechanically fabricated or injection molded to be a flow field board arrangement 1. Additionally, the flow field board arrangement 1 may be a complex flow field board with two or more materials described above.

The inject flow channels 12, the exhaust flow channels 13, the concave portions 14, the inlet 15, and the outlet 17 may be disposed on a single surface of the flow field board arrangement 1 or on both the top and bottom surfaces of the flow field board arrangement 1, insomuch, a single-sided or two-sided flow field board arrangement 11 is manufactured.

Fuel can be supplied for each concave portion 14 almost at the same time, and products within each concave portion 14 can be drained out of the outlet 17 almost at the same time by the flow field board arrangement 1. Moreover, products are pushed against one another when drained out in the flow field board arrangement 1. Hence, if the MEAs 21 produce bubbles during the electrochemical reaction, the bubbles are also pushed out completely without leaving in the flow field board arrangement 1.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A flow field board arrangement for fuel cell, comprising:
a substrate, including:
at least an injection flow channel disposed on a surface of the substrate;
at least an exhaust flow channel disposed on a surface of the substrate; and
at least a concave portion disposed on a surface of the substrate, and each concave portion is connected to the injection flow channel and the exhaust flow channel;
an inlet disposed on a side of the substrate and connected to an end of said injection flow channel; and
an outlet disposed on a side of the substrate and connected to an end of said exhaust flow channel;
wherein the flow field board arrangement is characterized in that each injection flow channel has an identical length from an influx end of the concave portion to the inlet and/or has an equivalent flow rate, and each exhaust flow channel has an identical length from an efflux end of the concave portion to the outlet and/or has an equivalent flow rate, and each injection flow channel has a length identical to each exhaust flow channel, and the flow rate of each injection flow channel is the same as each exhaust flow channel.

2. The arrangement of claim 1, wherein the concave portion is disposed corresponding to a membrane electrode assembly (MEA).

3. The arrangement of claim 1, wherein the concave portion is a zigzag trench.

4. The arrangement of claim 3, wherein each zigzag trench has the same arrangement.

5. The arrangement of claim 1, wherein the concave portion is a diamond network trench.

6. The arrangement of claim 5, wherein each diamond network trench has an identical arrangement.

7. The arrangement of claim 1, further comprising at least a diverging region.

8. The arrangement of claim 1, further comprising at least a converging region.

9. The arrangement of claim 1, wherein the flow field board arrangement is a two-sided flow field board.

10. The arrangement of claim 1, wherein the flow field board arrangement is a single-sided flow field board.

11. The arrangement of claim 1, wherein the substrate is an acid-resisting and anticorrosive metal substrate, a plastic substrate, an epoxy glass fiber substrate, a ceramic substrate, a polymer plastic substrate, or a composite substrate thereof.
